(19) United States
(12) Patent Application Publication
(10) Pub. No.: US 2004/0050611 A1
(43) Pub. Date: Mar. 18, 2004

(54) Transporter storage and conveyance

(75) Inventors: Dean L. Kamen, Bedford, NH (US); R. William Arling, Windham, NH (US); J. Douglas Field, Bedford, NH (US); Lou Kozar, New Boston, NH (US); Richard Lanigan, Concord, NH (US); Phil LeMay, Bedford, NH (US); B. Michael Taylor, Exeter, NH (US)

Correspondence Address: BROMBERG & SUNSTEIN LLP, 125 SUMMER STREET, BOSTON, MA, 02110-1618, US

(73) Assignee: DEKA Products Limited Partnership, Manchester, NH (US)

(21) Appl. No.: 10/633,733

(22) Filed: Aug. 4, 2003

Related U.S. Application Data
(63) Continuation-in-part of application No. 10/308,888, filed on Dec. 3, 2002.
(60) Provisional application No. 60/336,601, filed on Dec. 5, 2001.
(60) Provisional application No. 60/347,800, filed on Jan. 10, 2002.
(60) Provisional application No. 60/451,711, filed on Mar. 3, 2003.

(51) Int. Cl. B62H 5/00; B60R 25/00

(52) U.S. Cl. 180/287

(57) ABSTRACT

An installation for hitching at least one personal transporter in a fixed position relative either to an immobile fixture or another conveyance. The installation has a clasp for coupling a personal transporter in such a manner as to immobilize the transporter. The installation may also have a powering junction for supplying electrical power to the personal transporter, a data connection for transferring information between the installation and the personal transporter, and a heater for heating the personal transporter. Straps may be provided to allow the transporter to be loaded onto a conveyance by wrapping the straps around the driven wheels of the transporter.

The present application is a continuation-in-part of U.S. patent application Ser. No. 10/308,888, filed Dec. 3, 2002, and claims priority from U.S. Provisional Patent Applications 60/336,601, filed Dec. 5, 2001, and No. 60/347,800, filed Jan. 10, 2002, and also claims priority from U.S. Provisional Patent Application No. 60/451,711, filed Mar. 3, 2003, all of which applications are incorporated herein by reference.

### TECHNICAL FIELD

The present invention pertains to methods and apparatus for personal transportation in an urban environment, including intermodal conveyance of personal transporters aboard other modes of transportation and for storage of personal transporters while not in use, whether stationary or in transit.

### BACKGROUND OF THE INVENTION

A wide range of vehicles and methods are known for transporting human subjects. Typically, such vehicles rely upon static stability, being designed so as to be stable under all foreseen conditions of placement of their ground-contacting members. (The term ‘ground’, as used herein, refers, without limitation, to the surface supporting the transporter from below, and, while not so limited, the ground-contacting members of a transportation device are typically wheels.)

Stable vehicles are readily parked, given sufficient real estate to do so, and, with brakes set, may be safely left for the return of the user. Light personal vehicles such as bicycles or scooters require specialized fixtures such as bicycle racks. Neither of these parking modalities are optimal for a personal transportation device having laterally disposed wheels, such as the human transporter shown in FIG. 1.

Additionally, specialized modalities are desirable for enabling a person, such as an urban commuter, for example, to be transported by a first mode of transportation conveying a personal transporter along with the person for subsequent use after disembarking from the first mode of transportation. Thus, for example, it would be desirable to enable a person to be transported from a distant region, on a train, along with a personal transporter that would serve for subsequent locomotion of the person after disembarking from the first mode of transportation, such an arrangement collectively referred to as intermodal transportation.

### SUMMARY OF THE INVENTION

In accordance with a preferred embodiment of the present invention, there is provided an installation for hitching at least one personal transporter having a chargeable power supply in a fixed position. The installation has a fixture; and a clasp for coupling a personal transporter in such a manner as to immobilize the transporter. In accordance with other embodiments of the invention, the installation may also have a powering junction for supplying electrical power to the personal transporter, a data connection for transferring information between the installation and the personal transporter, and a heater for heating the personal transporter. The fixture may be a seat, in fact, the fixture may advantageously fulfill multi-functional purposes and additionally serve, for example, as a park bench or bus-stop bench, and, may furthermore, additionally provide heating, light, or communications services.

In accordance with other embodiments of the invention, an apparatus is provided for storing a plurality of personal transporters. The apparatus has a conveyor and a plurality of shuttles coupled to the conveyor, each shuttle adapted for carrying a single personal transporter.

In another embodiment, a fixture is provided for allowing a personal transporter to be walked up a wall by means of a reel arrangement coupled to the transporter thereby facilitating storage of the transporter.

In accordance with yet further embodiments of the invention, an apparatus is provided for carrying a personal transporter on a ground conveyance, wherein the apparatus has a dock coupled to the ground conveyance and one or more of clasps, each clasp adapted for coupling a personal transporter to the dock. A slot is provided in the clasp for capturing a grab bar disposed on the transporter such that the control column of the transporter may provide leverage about the grab bar so as to lift the transporter off the ground for conveyance. Straps may be provided to allow the transporter to be loaded onto a conveyance by wrapping the straps around the driven wheels of the transporter.

### BRIEF DESCRIPTION OF THE DRAWINGS

The invention will be more readily understood by reference to the following description, taken with the accompanying drawings, in which:

FIG. 1 shows a human transporter to which the present invention may advantageously be applied;

FIG. 2 is a schematic depiction of a system for customizing the control characteristics of a transporter in accordance with preferred embodiments of the present invention;

FIG. 3 is a perspective view of a transporter hitching structure modality in accordance with preferred embodiments of the present invention;

FIG. 4a is a schematic side view of a stacking arrangement for high-density storage of personal transporters in accordance with an embodiment of the present invention;

FIG. 4b is a schematic side view of a further stacking arrangement for high-density storage of personal transporters in accordance with another embodiment of the present invention;

FIG. 4c is a schematic view of a reel arrangement for walking a personal transporter up a wall in accordance with the present invention;

FIG. 5a is a side view of a car carrier for transporting a personal transporter in accordance with an embodiment of the present invention;

FIG. 5b is a side view of a car carrier for transporting a personal transporter in accordance with another embodiment of the present invention;

FIG. 6A is a side view of a human transporter showing a grab pin for storage or conveyance in accordance with embodiments of the present invention;

FIG. 6B is a perspective view of a rack of receivers for conveyance of one or more transporters in accordance with the present invention;

FIGS. 7A-7C show a mounting cradle and its use to capture a transporter for purposes of conveyance or storage in accordance with embodiments of the present invention;

FIG. 8 is a perspective view of a human transporter and an associated carrier for conveyance or storage in accordance with further embodiments of the present invention;

FIG. 9 is a schematic view of a spool arrangement for walking a personal transporter up a car in accordance with the present invention; and

FIG. 10 is a rack for intermodal transportation of multiple personal transporters aboard a public conveyance such as a train, in accordance with embodiments of the present invention.

### DETAILED DESCRIPTION OF SPECIFIC EMBODIMENTS

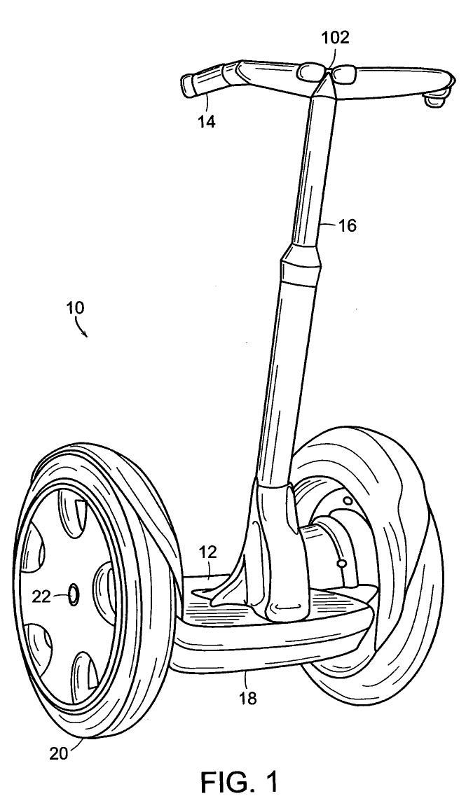

A personal transporter, such as that shown in FIG. 1 and designated there generally by numeral 10, is described in detail in U.S. Pat. No. 5,971,091 and is an example of a device to which the present invention may advantageously be applied. A subject (not shown) stands on a support platform 12 and holds a grip 14 on a handle 16 attached to the platform 12, so that the vehicle 10 may be operated in a manner analogous to a scooter. A control loop may be provided so that leaning of the subject results in the application of torque to wheel 20 about axle 22 thereby causing an acceleration of the vehicle. Transporter 10, however, is statically unstable, and, absent operation of the control loop to maintain dynamic stability, the transporter will no longer be supported in its operating position. Different numbers of wheels or other ground-contacting members may advantageously be used in various embodiments of the invention as particularly suited to varying applications. Thus, the number of ground-contacting members may be any number equal to, or greater than, one. Transporter 10 may advantageously be used as a mobile work platform or a recreational vehicle such as a golf cart, or as a delivery vehicle.

Transporter 10 is typically powered by battery unit 18 disposed beneath platform 12. The transporter may be operated in a station-keeping mode, wherein balance is maintained substantially at a specified position. Additionally, transporter 10, which may be referred to herein, without limitation, as a “vehicle,” may also maintain a fixed position and orientation when no user is on platform 12. This mode of operation, referred to as a “kickstand” mode, prevents runaway of the transporter and provides for the safety of the user and other persons. A forceplate or other sensor, disposed on platform 12, may detect the presence of a user on the transporter.

Other embodiments of a balancing transporter in accordance with the present invention may have clusters each cluster having a plurality of wheels. Supplemental ground-contacting members may be used in stair climbing and descending or in traversing other obstacles. In one mode of operation, for example, it is possible to rotate clusters so that two wheels on each of the clusters are simultaneously in contact with the ground. Stair climbing and flat-terrain locomotion may both be achieved, however, with the vehicle supported on only a single set of primary ground-contacting members.

Personal Controller Key

As described in the foregoing discussion, dynamically-stabilized personal transporters utilize electronic control for balancing and other operations. This “fly-by-wire” nature lends itself to tailoring the control system of a transporter to the personal characteristics of an individual rider that may affect the operation of a dynamically-stabilized transporter in many ways. In one instance, characteristics such as physical dimensions of the rider may affect the stability of the transporter. Therefore, specific settings of the balance controller and yaw controller may be set to optimize the control of the transporter. In another instance, the control system may be programmed to accommodate designated rider preferences to improve the comfort and pleasure of the rider. In a third instance, operating limits of specific parameters of the transporter may be commanded by the control system to accommodate personal characteristics of a rider, optimize the parameters for the specific operational environment, or allow a rider to select different parameter limits in accordance with the rider's training or experience.

The control system of the transporter typically utilizes specific values of control parameters that operate the control system of the transporter in accord with personal characteristics of the rider. Personal characteristics may also be stored in the form of a tailored set of control parameters and operating limits of the transporter. The controller data device may be programmed at the discretion of the individual rider or pre-programmed by the transporter manufacturer or distributor. Alternatively, the controller data device may be designed such that the transporter manufacturer or distributor may restrict other entities, including individual riders, from programming particular parameters over certain values or not allowing any programming of particular parameters.

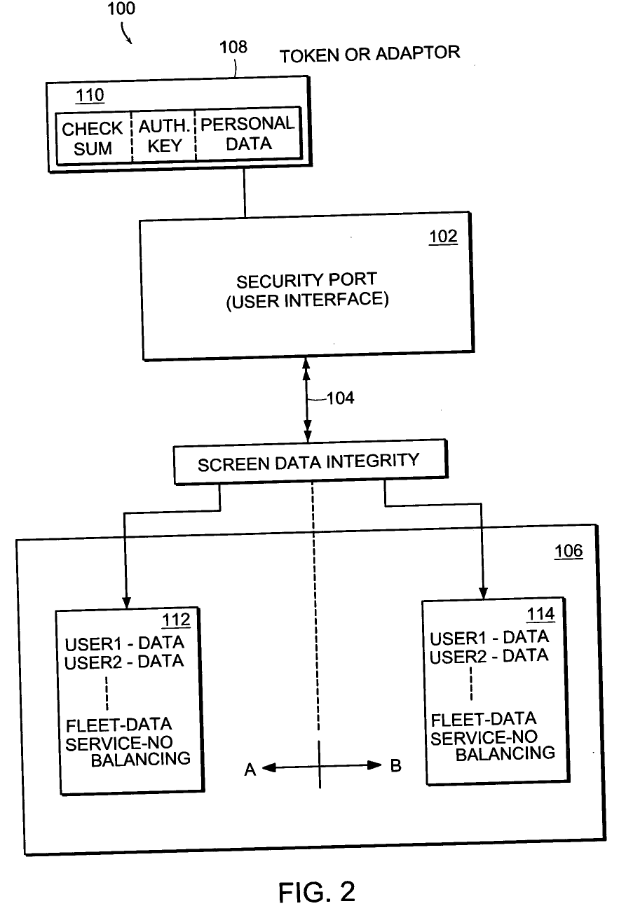

In accordance with preferred embodiments of the invention, a security port 102 is provided, preferably disposed on the top portion of stalk 16, for interfacing with a personal data token, as described below. Referring now to FIG. 2, a block diagram is provided depicting a security system 100 in accordance with preferred embodiments of the present invention. A security port 102 is provided, preferably disposed on stalk 16 as depicted in FIG. 1. Security port 102 provides access to a data line 104 providing for the flow of data between an external device and both processors A and B of a redundant transporter control system 106. Various devices may be coupled to security port 102 in order to exchange data with control system 106.

One class of such peripheral devices includes a token 108 which may also be referred to as a ‘smart key.’ Token 108, shown schematically in FIG. 2, comprises a data memory 110 in which are stored an Authentication Key uniquely identifying a user, along with Personal Data associated with the uniquely identified user that may, in turn, be employed by the transporter control system 106 to govern specified operating parameters.

Each processor A and B contains a separate sealed memory, 112 and 114, respectively, in which parameters characterizing potential users of the transporter may be stored. The contents of memories 112 and 114 may not be accessed from outside the transporter, thus preserving the security of the device.

Data may be associated with individual users, and, additionally, with the management of a fleet of transporters, and, further, with operators, such as service personnel, who are not to be empowered to operate the transporter in a balancing mode, are stored in memories 112 and 114.

After data provided by token 108 are screened for data integrity, employing a checksum embodied in the token data memory, if present, the authentication key and personal data embodied in token 108 are used to select the appropriate operating parameters for the transporter from the data stored in memories 112 and 114. The contents of the redundant memories may be crosschecked for integrity.

It is notable, in accordance with preferred embodiments of the present invention, that data may also flow from the transporter controller 106 to the token. Thus, for example, a record may be kept, within memory 110 of the token itself, as to particular features of the operating history of the transporter with an identified user in control of the transporter. The record may includes such features as the number of hours of operation performed by a particular user, the speeds and operating features employed by the user, hours of the day during which operation occurred, user behavior (characterizing smoothness of operation), etc. Moreover, cumulative data may be maintained, either on board the device, or as downloaded onto a token or other memory. The use record thus derived from operation of the transporter may be advantageously employed, for example, to provide a basis for built-in qualification, training of a user; the user record allows determination as to whether a particular user has sufficient experience to be qualified to operate more substantial functionalities of the transporter and user access to various functionalities may be limited until the user is qualified.

The use record, thus derived, may also advantageously provide for use logging, for purposes of maintenance records or for management of a fleet of transporters. Place of operation, duration and speed of travel, and user identity may be logged.

Wireless notification of a fleet manager may be provided in case of specified circumstances such as unauthorized use.

Token 108, which identifies a specified user, may take the form, for example, of a programmable I-Button™, available from Dallas Semiconductor. Token 108 may be programmed remotely, and may be required to be enabled remotely, as by a code provided electronically by telephone or via the Web.

Token 108 may be equipped with a wireless transmitter or transceiver for communicating with an individual specified transporter so as to produce a visual and/or an audible response thereby identifying the specified transporter to a user.

In accordance with certain embodiments of the present invention, the transporter may be entirely disabled and, moreover, prevented from rolling, when not properly authorized by means of token 108 or by an authorized proxy. More particularly, the motor windings may be shorted when the transporter is not properly authorized for use.

Hitching Structure

The small footprint as well as the built-in capability to identify a user and user-associated functionalities, allow for particularized modes of use for balancing human transporters.

In accordance with many exigencies of daily life, a person may wish to spend a short period of time engaged in an activity at some location, and then to move to another location to engage in another activity, and so on to other subsequent locations. This modality describes, for example, the course of a person shopping and moving from one store to another, or, in other cases, the course of a person's workday.

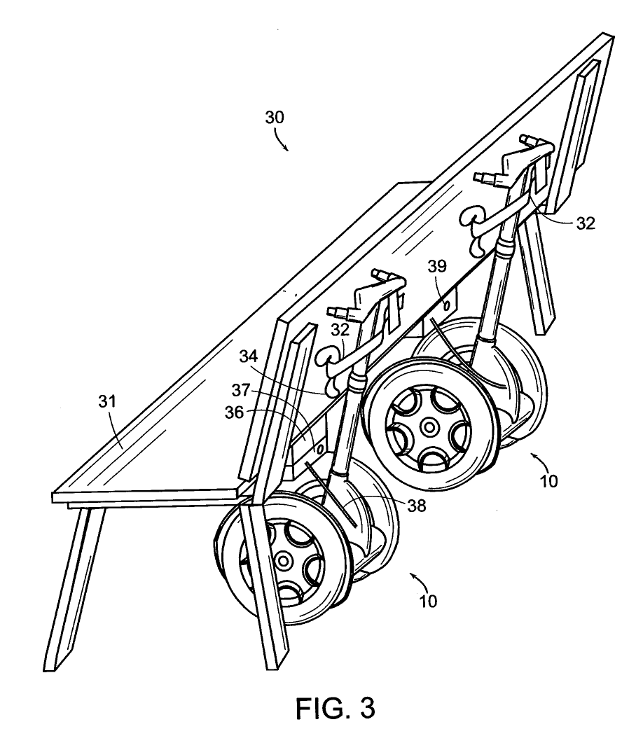

Referring to FIG. 3, a hitching structure, designated generally by numeral 30 is shown. Hitching structure 30 is a fixture typically disposed in a publicly accessible venue to which one or more personal transporters 10 may be temporarily attached. Hitching structure 30 may be a fixture serving another function other than temporary hitching of a personal transporter. For example, as shown in FIG. 3, hitching structure 30 may be a park bench or a bench on a city street, or, alternatively, a seat in a restaurant or other common gathering area, and may be provided by a public entity or by one or more merchants as a convenience to the public. Since, as discussed below, hitching structure 30 is preferably provided with electrical power, and, possibly, also communications connections, the presence of an identified transporter may advantageously be logged, such as for purposes of fleet tracking or rental to successive users.

Hitching structure 30 has one or more clasps 32, each clasp for securing a personal transporter 10 to the hitching structure 30 in such a manner that the transporter is maintained in a static position with respect to the hitching structure. Clasp 32 may also provide for controlling access to a particular transporter such as by locking the transporter with lock 34 that allows access only to a person having a specified token (such as a key) or code (such as a combination of numbers).

Additionally, hitching structure 30 provides powering junctions 36 for supplying electrical power to transporters 10 via electrical coupling 38 which may be a cable, for example. The power supplied may be metered, with the transporter 10 identifying itself to the powering junction 36 via the electrical coupling 38, or, in an alternative business model, the power may be provided without cost to the user. In yet another business model, the user of transporter 10 may use the same token 108 (shown in FIG. 2) as described above for identifying the user and user parameters to the security port of a transporter, for the additional purpose of identifying the user to powering junction 36 of a hitching structure 30. Token 108, which, as discussed, may take the form of a programmable I-Button™, is tapped onto data port 39 of electrical coupling 38, and either an account of the user is charged for electrical power supplied or else credits may be logged on the I-Button™ by prepayment and applied against charges for electrical power supplied. In case unauthorized use is to be precluded, the motor drive may be shunted in a default condition, in such a manner as to substantially prevent rolling of any wheel; while the shunt across the motor drive may be removed in response to authorization of a specified user to operate the transporter.

In addition to providing electrical power, hitching structure 30 may include heating units 37, heated, for example, by ohmic heating of a heating element, in order to warm the battery units 18 (shown in FIG. 1) of the transporters and, optionally, also to heat any seating surface 31 of the hitching structure.

Hitching unit 30 may provide for attachment of multiple transporters in a linear side-by-side configuration as depicted in FIG. 3, however the disposition of transporters is by no means so limited. Indeed, hitching unit 30 may assume a circular shape, and additionally, hitching unit 30 may be rotatable in place, with individual transporters accessible from various positions on the ground, with the hitching unit serving transporters in the manner of a ‘lazy Susan’.

Stacked Storage

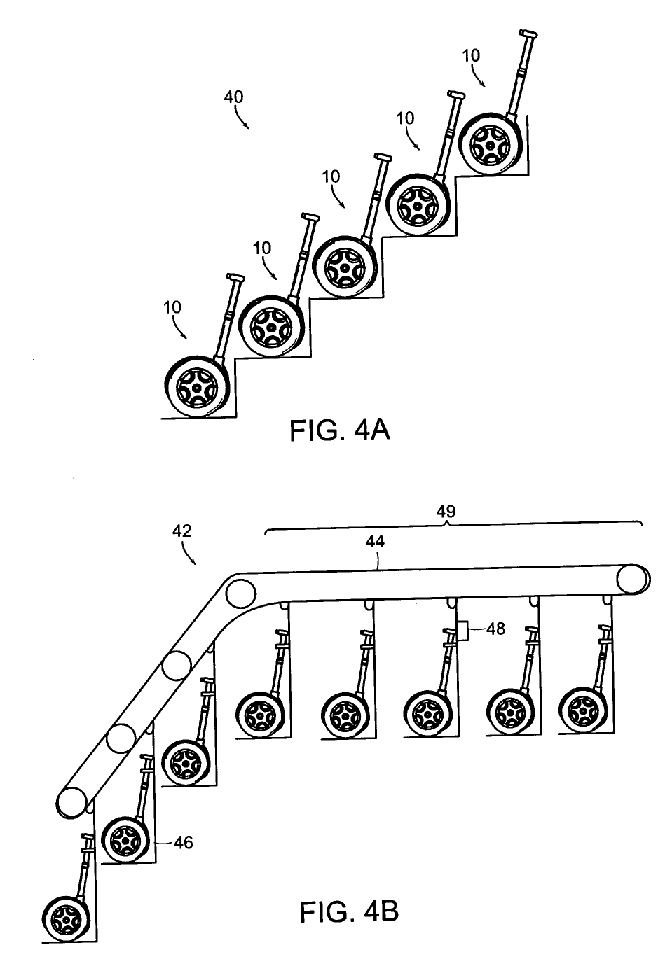

In circumstances where longer-term storage of personal transporters than provided by the hitching structure of FIG. 3 is contemplated, a stacking structure 40, as depicted in FIG. 4a, may be provided for achieving higher transporter storage densities than afforded in side-by-side storage modalities. Multiple transporters 10 may be stacked, one elevated above its immediate neighbor by being conducted to a higher elevation in the ‘follow mode’ of conducted operation described in co-pending U.S. Provisional Patent Application Serial No. 60/388,937, filed Jun. 14, 2002 and incorporated herein by reference.

Alternatively, multiple transporters 10 may be stored in the rack storage 42 depicted in FIG. 4b, in which the transporters are lifted, in ski-lift fashion, by chain mechanism 44, each transporter being supported by a separate shuttle 46. Alternatively, transporters may be lifted directly by their handles 14 (shown in FIG. 1). Chain mechanism 44 lifts each transporter unit off of the floor from a common launch location and places the unit as a member of a set of traveling units that are positioned for dense storage in a conveyor rack 49, as commonly done with dry cleaning.

In either of the storage modalities depicted in FIGS. 4a and 4b, transporter units may be locked into place and electrical connection may be provided between the support structure and each transporter for data connectivity, to identify the location of a specified transporter, and/or for supplying battery charging current to the transporter. Data connectivity between the transporter security port 102 and a reading device 48 permits the determination of individual transporter serial numbers and identifying information by law enforcement and other personnel.

Referring now to FIG. 4c, in accordance with further embodiments of the invention, human transporter 10 may be provided with a spool 43 for taking up cable 41 thereby elevating transporter 10, using its own power, to a storage place high on a wall, for example, or otherwise out of the way. Alternatively, transporter 10 may be raised or lowered by operation of the opposite end of cable 41 acting through pulleys 45, shown by way of example.

Car and Truck Carriers for Personal Transporters

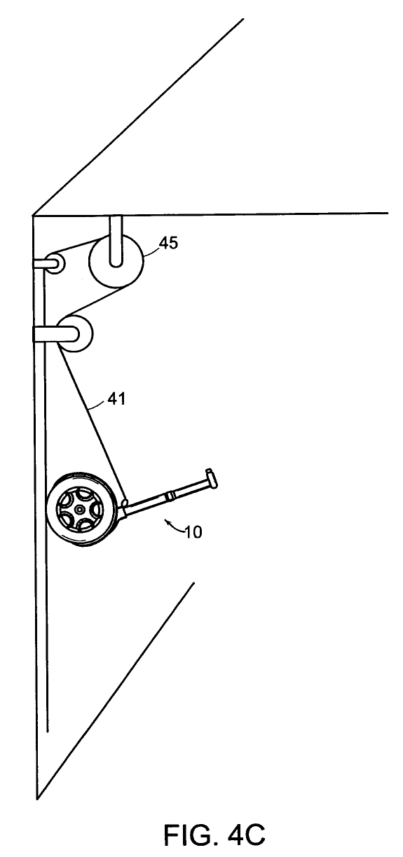

Referring now to FIG. 5a, a carrier 50 is depicted, in accordance with an embodiment of the present invention, for coupling a transporter to a road vehicle, such as an automobile 51. Carrier 50 mounts to automobile 51 via a square receiver hitch 52. A personal transporter (not shown) is maneuvered by a user (employing, for example, the ‘follow-mode’ of user-conducted operation described in U.S. Provisional Application No. 60/388,937) over deck 53 of the carrier, the deck being angled by angle α with respect to horizontal 54 for convenient loading of the transporter. During the loading process, deck 53 remains underneath chassis 12 of the transporter (shown in FIG. 1). In the embodiment shown in FIG. 5a, wheels 20 of the transporter are driven until they establish frictional contact with friction roller 55, while the chassis 12 of the transporter (FIG. 1) rests on deck 53. Continued rotation of wheels 20 may then be used to transfer torque to friction roller 55 which, in turn, drives spooling web belt 56 to raise the lower section of carrier 50, borne on rollers 57, until reaching spring-loaded catch 58. Deck 53 is thus maintained in an elevated position at the top of the stroke of the lower carrier section. Lock 59 may then be employed to lock the transporter in place.

Alternatively, as depicted in FIG. 5b, an articulated ramp 60 may be employed to secure personal transporter 10 to ground vehicle 51. Transporter 10 is driven up articulated ramp 60 while in the extended position shown. In the articulated position, with distal member 62 rotated clockwise about knee 64, articulated ramp 60 traps the uploaded transporter, in which position the distal member may be latched in its folded position to the ground vehicle by means of latch 66.

Trucks, such as postal delivery trucks, for example, may advantageously employ the approach described in the foregoing paragraph, with the personal transporter deployed for house-to-house delivery of mail. Ramp 60 may be stored, for example, for underneath the floor of the truck. The ramp may encompass only a fraction, such as a half, of the lateral breadth of the back of the truck, thereby leaving another side of the back of the truck free for loading cargo.

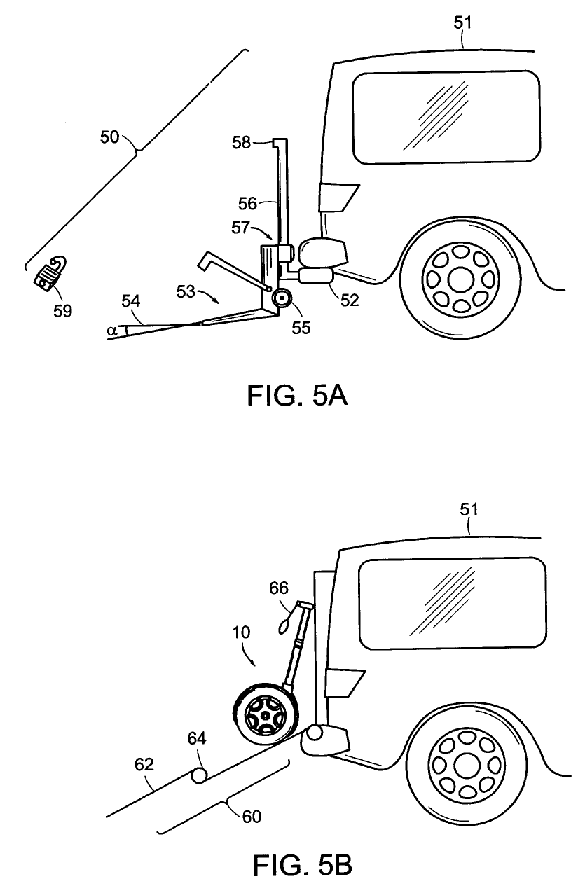

Particular embodiments for mounting one or more transporters to a motorized vehicle (or for storage of transporters in a fixed location) are now described with reference to FIGS. 6A and 6B. A pin 70 or grab bar is disposed on the prow 72 of human transporter 10 as shown in the schematic cross section of FIG. 6A. A mounting bar, designated generally as 74, is shown in FIG. 6B. Five clasps (or “receivers”) 76 and 77 are shown coupled to the mounting bar, though a mounting bar with a single receiver or any number of receivers is within the scope of the present invention. Each receiver 76 is pivotally coupled to the mounting bar about one or more pivots 78. Receiver 76 has a slot 80 in which pin 70 of the transporter is captured. Receiver 77, shown in a tipped or loading position, is then righted into the carrier position of receiver 76. In the carrier position, receiver 76 retains column 8 of the transporter along axis 82, the column being retained by a retaining mechanism, such as by being pinned in place by pin 84, shown as an example of a retaining mechanism. A neck 88 fits a corresponding receiver (not shown) on a carrying vehicle so as to support mounting bar 74 and any mounted transporters.

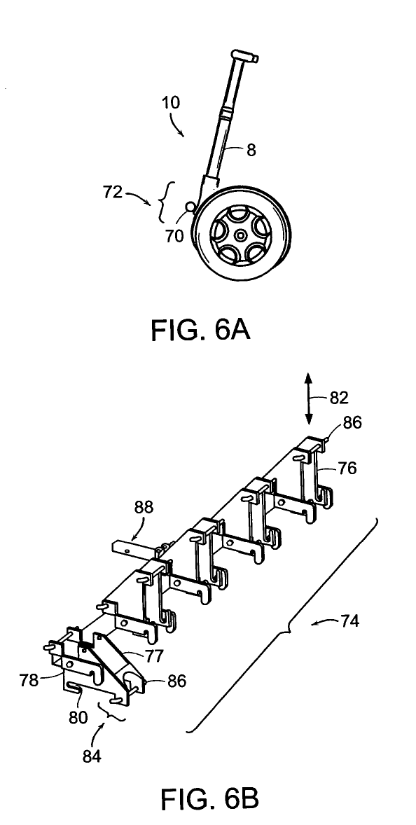

In order to address the issue of lifting the weight of a transporter in order to suspend it from a car or other vehicle, control column 8 of the transporter may be used to obtain a mechanical leverage advantage, as now described with reference to FIGS. 7A-7C. FIG. 7A shows a mounting cradle 700, referred to herein as a “saddle” or “carrier.” Pin or grab bar 70 (shown in FIG. 7B) of transporter 10 is captured in slot 80 whereas column 8 of the transporter is secured in collar 702 by means of pin 704. FIG. 7C shows the transporter as supported by saddle 700 for conveyance by a motor vehicle or for storage. In particular, saddle 700 may be coupled to a trailer hitch such that FIG. 7C represents transporter 10 lifted off the ground for purposes of conveying the transporter on a car or other vehicle.

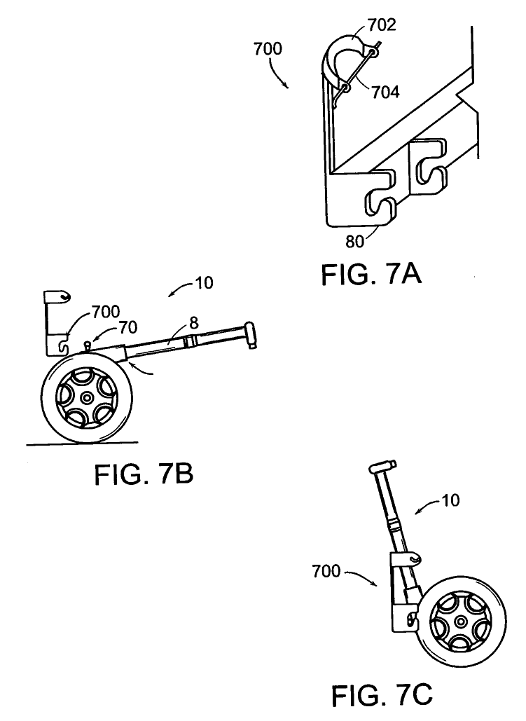

FIG. 8 shows transporter 10 equipped with grab bar 70. In accordance with preferred embodiments of the invention, transporter 10 is wheeled to the proximity of a vehicle (not shown) or fixture that will support the transporter in a position above the ground. Carrier 700 is pivotally attached, at pivot 800, to an adjustable height adaptor 802, the neck 804 of which is sized to fit a receiver which constitutes the hitch of a vehicle or fixture. Once transporter 10 has been wheeled on wheels 806, either by riding or by direction in ‘follow-mode’, to the proximity of carrier 700, grab bar 70 is maneuvered into slot (or ‘grab hook’) 80 of the carrier 700. Using column 8 of the transporter for leverage, transporter 10 is then readily pivoted about engaged grab bar 70 to lift it off the ground, such that column 8 is in alignment with collar 702. Column 8 may then be pinned such that it is retained in collar 702, and carrier 700 may be pinned in vertical alignment with height adaptor 802. Transporter 10 is thereby easily lifted onto the hitch of a vehicle or an off-ground fixed support.

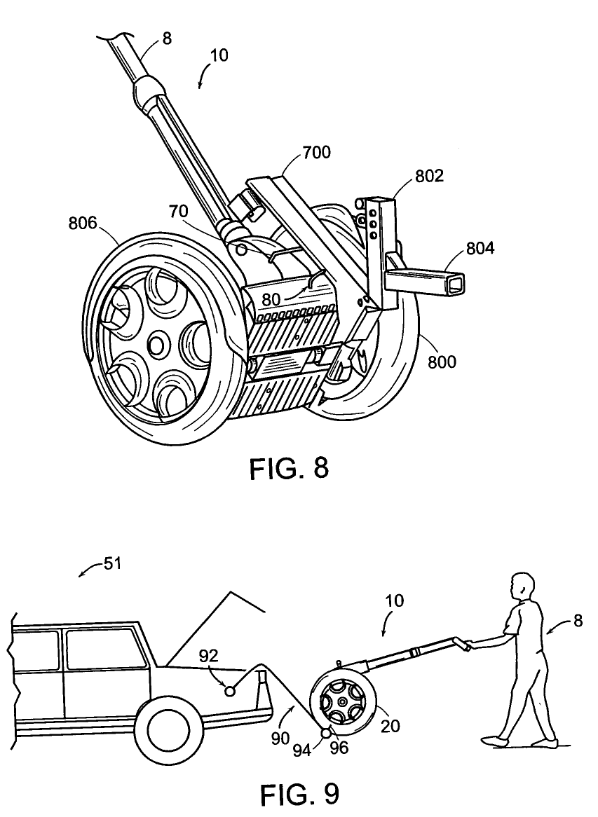

In accordance with a further embodiment of the invention, described now with reference to FIG. 9, operator 8 drives transporter 10 up one or more straps 90, which are attached at one end 92 to a car or other vehicle 51, while the proximal end 94 of each strap is attached, by clip 96, to respective wheels 20 of the transporter. Thus, the torque of the wheels, as controlled by the operator in ‘follow mode’, may be used to raise the transporter for storage or conveyance by vehicle 51. Follow mode is a mode of operation that allows the operator to govern rotation of wheels 20 without riding on the transporter, and is described in copending U.S. application Ser. No. 10/462,379, filed Jun. 16, 2003, and incorporated herein by reference. Straps 90 may be nylon or another flexible material conveniently wrapped about transporter wheel 20 or about a spool co-rotating with the wheel, such that the strap is wrapped about an axis that is coaxial with the axis of rotation of the wheel.

Carriers for Personal Transporters on Public Transportation

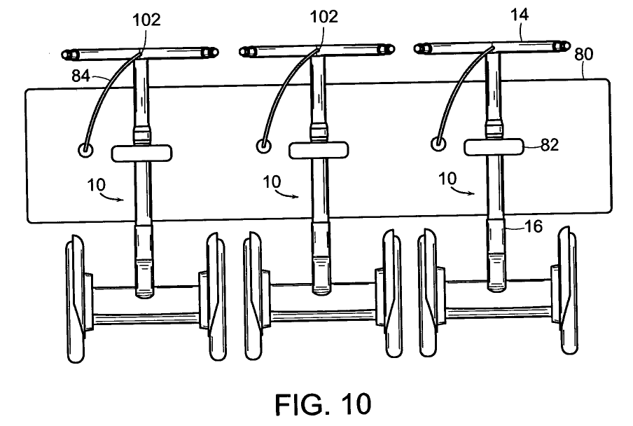

Referring now to FIG. 10, in accordance with further embodiments of the present invention, an arrangement is provided, either for an accessible interior compartment or for the exterior of a public conveyance such as a bus, a train, a subway, an airplane, a boat, etc., for holding and possibly charging one or more personal transporters. Multiple transporters 10 are locked to dock 80 by clasps 32, using either grip bar 14 or handle 16 of the transporters, for example, to secure the transporters to the dock. Additionally, electrical coupling may be provided between dock 80 and the user interface ports 102 of the transporters, via cables 84, to supply electrical charge to the transporters, and/or, as described above with reference to the fixed hitching structure, to identify users, such as might be advantageous either for billing purposes or in case of loss or accident as by tracking lost and stolen transporters. Such utility is enabled with limited information is accessible to non-owners from memories 112 and 114 (see FIG. 2) via data port 102.

The described embodiments of the invention are intended to be merely exemplary and numerous variations and modifications will be apparent to those skilled in the art. All such variations and modifications are intended to be within the scope of the present invention as defined in the appended claims.

We claim:

1. An installation for hitching at least one personal transporter having a chargeable power supply, the installation comprising:
a. a fixture; and
b. a clasp for coupling a personal transporter in such a manner as to immobilize the transporter.

2. An installation in accordance with claim 1, further comprising a powering junction for supplying electrical power to the at least one personal transporter.

3. An installation in accordance with claim 1, further comprising a data connection for transferring information between the installation and the at least one personal transporter.

4. An installation in accordance with claim 1, further comprising a heater for heating the at least one personal transporter.

5. An installation in accordance with claim 1, wherein the fixture is a seat.

6. A carrier for supporting a personal transporter having a grab bar and a column disposed substantially vertically during operation, the carrier comprising:
a. a receiver having a slot for capturing the grab bar of the personal transporter;
b. a collar for receiving the column of the personal transporter; and
c. a retaining mechanism for retaining the column within the collar.

7. A carrier according to claim 6, wherein the receiver is pivotally coupled to a mounting bar about a horizontal pivot.

8. A carrier according to claim 6, wherein the retaining mechanism includes a retaining pin.

9. An apparatus for storing a plurality of personal transporters, the apparatus comprising:
a. a conveyor; and
b. a plurality of shuttles coupled to the conveyor, each shuttle adapted for carrying a single personal transporter.

10. An apparatus for carrying a personal transporter on a ground conveyance, the apparatus comprising:
a. a dock coupled to the ground conveyance; and
b. a plurality of clasps, each clasp adapted for coupling a personal transporter to the dock.

11. A method for storing a personal vehicle comprising:
a. locking the personal vehicle to a fixture; and
b. supplying charging current to the personal vehicle.

12. A method for conveying a personal vehicle aboard a public conveyance, the method comprising:
a. providing a dock aboard the public conveyance; and
b. locking the personal transporter to the dock.

13. A method for preventing unauthorized use of a personal transporter driven by a motor drive, the method comprising:
a. shorting the motor drive in a default condition, in such a manner as to substantially prevent rolling of any wheel; and
b. removing any shunt across the motor drive in response to authorization by means of a token.

14. A method for loading a personal transporter having a wheel rotatable about an axle onto a conveyance, the method comprising:
a. attaching a first end of a strap to the conveyance;
b. coupling a second end of the strap to a wheel of the transporter; and
c. driving the wheel of the transporter so as to wrap the strap about an axis coaxial with the wheel axle thereby propelling the transporter onto the conveyance.
